(19) United States
(12) Patent Application Publication
(10) Pub. No.: US 2016/0168446 A1
(43) Pub. Date: Jun. 16, 2016

(54) METHOD FOR PRODUCING MINERAL OIL FROM AN UNDERGROUND MINERAL OIL DEPOSIT USING A COMPOSITION (Z) COMPRISING A GLYCEROL-BORIC ACID COMPLEX

(71) Applicants: WINTERSHALL HOLDING GMBH, Kassel (DE); INSTITUTE OF PETROLEUM CHEMISTRY OF THE SIBERIAN BRANCH OF THE RUSSIAN ACADEMY OF SCIENCES, Tomsk (RU)

(72) Inventors: Vladimir STEHLE, Kassel (DE); Altunina LIUBOV, Tomsk (RU); Vladimir KUVSHINOV, Tomsk (RU); Ivan KUVSHINOV, Tomsk (RU); Liubov STASYEVA, Tomsk (RU)

(73) Assignees: WINTERSHALL HOLDING GMBH, Kassel (DE); INSTITUTE OF PETROLEUM CHEMISTRY OF THE SIBERIAN BRANCH OF THE RUSSIAN ACADEMY OF SCIENCES, Tomsk (RU)

(21) Appl. No.: 14/902,688

(22) PCT Filed: Jul. 3, 2014
(86) PCT No.: PCT/EP2014/064174

§ 371 Date: Jan. 4, 2016

(30) Foreign Application Priority Data
Jul. 4, 2013 (EP) 13175169.5

(51) Int. Cl. C09K 8/58; E21B 43/16

(52) U.S. Cl. CPC C09K 8/58; E21B 43/16

(57) ABSTRACT

The present invention relates to a method for producing mineral oil from an underground mineral oil deposit using a composition (Z) and to the use of the composition (Z) as a medium for mineral oil production.

The present invention relates to a method for producing mineral oil from an underground mineral oil deposit using a composition (Z) and to the use of the composition (Z) as a medium for mineral oil production.

In natural mineral oil deposits, mineral oil is generally present in the cavities of porous reservoir rocks sealed by impervious top layers toward the surface of the earth. As well as mineral oil and natural gas, underground mineral oil deposits generally additionally comprise water of greater or lesser salt content. The cavities in which the mineral oil is present may be very fine cavities, capillaries, pores or the like. The cavities may, for example, have a diameter of only one micrometer. The water present in the underground mineral oil deposits is also referred to as deposit water or formation water. The salt content of the formation water is frequently 5 to 20% by weight. However, there also exist underground mineral oil deposits having formation water with a salt content of up to 27% by weight. The dissolved salts may for example, be alkali metal salts, but in some deposits the formation water also comprises relatively high proportions of alkaline earth metal ions, for example up to 5% by weight of calcium ions and/or magnesium ions.

In mineral oil production, a distinction is made between primary, secondary and tertiary production. In the case of primary production, after the well has been sunk (driven) into the underground deposit, the mineral oil flows of its own accord through the well to the surface because of the natural autogenous pressure in the mineral oil deposit. The autogenous pressure of the mineral oil deposit can be caused, for example, by gases such as methane, ethane or propane present in the deposit. Depending on the deposit type, primary mineral oil production can usually produce only 5 to 10% of the mineral oil present in the deposit. Thereafter, the autogenous pressure of the mineral oil deposit is no longer sufficient to obtain mineral oil from the underground mineral oil deposit through primary mineral oil production.

After primary mineral oil production, secondary mineral oil production is therefore used. In the case of secondary mineral oil production, additional wells are sunk (driven) into the mineral oil deposit. A distinction is generally made between what are called production wells and what are called injection wells. Through the production wells, mineral oil is produced from the underground mineral oil deposit to the surface. Through the injection wells, water is injected into the mineral oil deposit in order to maintain the pressure of the underground mineral oil deposit or increase it again. The injection of the water gradually forces the mineral oil through the cavities of the underground mineral oil deposit from the injection well proceeding in the direction of the production well. As a result, the mineral oil from the underground mineral oil deposit arrives in the production well and is produced to the surface, for example by means of pumps. However, this method of secondary mineral oil production works only for as long as the cavities of the underground mineral oil deposit are filled completely with mineral oil and the mineral oil, which has higher viscosity compared to water, is displaced by the water injected through the injection well. This state is shown by way of example in FIG. 1.

In FIG. 1, the cavity (3) is completely sealed by mineral oil (2). The water injected can therefore displace the more viscous mineral oil (2) from the cavity (3). FIG. 2 shows the state after the performance of secondary methods for mineral oil production. The injected water has displaced the mineral oil (2) from the lower region of the cavity (3). The mobile water therefore flows through the lower region of the cavity (3) in FIG. 2. The water takes the path of least resistance. It thus flows through the channel formed in the lower region of the cavity (3) of the underground mineral oil deposit. From this time onward, the water injected no longer displaces any oil, and instead flows from the injection well through the underground mineral oil deposit to the production well. In that case, essentially only the water injected is produced from the production well. This state is also referred to as water breakthrough.

Because of the different polarity of mineral oil and water, a high interfacial energy or interfacial tension exists between the two components. Therefore, the two components, mineral oil and water, assume the smallest contact area, which results in a spherical oil droplet which no longer fits through the cavity (3) of the underground mineral oil deposit. At the end of the methods for secondary mineral oil production, for example water flooding, the mineral oil (2) is thus trapped in the cavities (3) in discontinuous form, i.e. in individualized spherical droplets.

By the methods for primary and secondary mineral oil production, generally only about 30 to 35% of the total amount of the mineral oil present in the mineral oil deposit can be produced.

The prior art describes measures for further enhancing production from underground mineral oil deposits after completion of secondary mineral oil production. These measures are also referred to as tertiary mineral oil production. Tertiary mineral oil production includes, for example, heating methods which involve injecting hot water or steam into the mineral oil deposit. This lowers the viscosity of the mineral oil. Flooding media used for tertiary mineral oil production may additionally also be gases, for example carbon dioxide or nitrogen.

Tertiary mineral oil production additionally includes processes in which suitable chemicals are used as assistants for mineral oil production. These can be used to influence the situation toward the end of secondary mineral oil production, for example by water flooding, and thus also produce mineral oil which has been held hitherto in the cavities (3) in the underground mineral oil deposit.

Viscose and capillary forces act on mineral oil which is trapped in the cavities (3) of the underground mineral oil deposit toward the end of secondary production. The ratio of these two forces to one another determines the microscopic oil removal. By means of a dimensionless parameter, called the capillary number (N_{c}), the effect of these forces is described. This is the ratio of the viscosity forces (i.e. the velocity multiplied by the viscosity of the phase injected as the flooding medium) to the capillary forces (i.e. the interfacial tension between oil and water multiplied by the wetting of the rock in the underground mineral oil deposit (1)). The capillary number (N_{c}) is calculated here by the following formula:

$${N}_{c} = \frac{μ v}{σ cos θ}$$

In this formula, μ is the viscosity of the fluid which mobilizes the mineral oil, ν is the Darcy velocity (flow rate per unit area), σ is the interfacial tension between the mineral oil-mobilizing liquid and the mineral oil, and θ is the contact angle between mineral oil and the rock in the underground mineral oil deposit (1). The capillary number has been described, for example, in C. Melrose, C. F. Brandner, J. Canadian Petr. Techn. 58, October-December 1974. The higher the capillary number (N_{c}), the greater the mobilization of the mineral oil and hence also the degree of oil removal from the underground mineral oil deposit.

Toward the end of secondary mineral oil production, the capillary number (N_{c}) is generally in the region of about 10⁻⁶. In order to be able to mobilize additional mineral oil from the underground mineral oil deposit, the capillary number (N_{c}) has to be increased to about 10⁻³ to10⁻².

For this purpose, for example, the interfacial tension a between mineral oil and aqueous phase can be lowered by the addition of suitable surfactants. This technique is also known as “surfactant flooding”. For this purpose, for example, surfactants which can lower the interfacial tension a to values <10⁻² mN/m are suitable.

In this manner, the mineral oil droplets can change shape and be forced through the cavities (3), i.e. the capillary orifices, by the flooding water. In addition, it is important to increase the contact angle θ. The surrounding rock (1) of the underground mineral oil deposit is generally hydrophobic. This means that the mineral oil present in the underground mineral oil deposit accumulates preferentially on the surrounding rock (1) of the underground mineral oil deposit.

The state toward the end of secondary mineral oil production is shown here by way of example in FIG. 3a. The mineral oil (2) wets the rock surface (1). In order to enhance the degree of oil removal, the prior art describes processes in which the hydrophobic properties of the rock (1) are converted to hydrophilic properties. For this purpose, the underground mineral oil deposit is treated with suitable chemicals. FIG. 3 shows, by way of example, the behavior of the mineral oil (2) when the rock stratum (1) is hydrophilized. FIG. 3a shows the state of a very substantially hydrophobic rock stratum (1). FIG. 3e shows the state after the rock stratum (1) has been converted by means of suitable chemicals to one having hydrophilic character. FIGS. 3b to 3d show the intermediate steps in the course of conversion of the character of the rock (1) from hydrophobic character to hydrophilic character. When the rock (1) of the underground mineral oil deposit has a hydrophilic character (see FIG. 3e), the contact angle θ is increased. The area of the rock (1) to which the mineral oil (2) adheres is minimized as a result. The mineral oil (2) is thus converted to a spherical shape (see FIG. 3e). This distinctly increases the mobility of the mineral oil (2), and the mineral oil droplets (see FIG. 3e; reference numeral 2 or FIG. 4) can be flushed out of the cavities (3) with the flooding medium (see FIG. 5).

The mineral oil (2) present in underground mineral oil deposits generally has a boundary layer (2a) which surrounds the mineral oil (2). This boundary layer (2a) is thus between the mineral oil phase (2) and the phase of the flooding medium. This boundary layer (2a) generally comprises high molecular weight hydrocarbons, tars, asphaltenes, heteroaromatic compounds and mineral particles having colloidal dispersity.

The boundary layer (2a) generally has a gel-like consistency with high viscosity. The boundary layer (2a) thus constitutes a mechanical barrier between the flooding medium phase and the mineral oil phase. The boundary layer (2a) thus prevents the above-described processes and effects for tertiary mineral oil production. The boundary layer (2a) is shown by way of example in FIG. 6.

In order to improve the oil removal from an underground mineral oil deposit, it is thus generally not sufficient to lower the interfacial tension between the mineral oil/water phase (or the mineral oil/flooding medium phase), or to increase the hydrophilic character of the surrounding rock (1). Instead, it is frequently necessary to destroy or to destabilize the boundary layer (2a). The destabilization is also referred to as destructuring.

The prior art describes methods for destructuring the boundary layer (2a). In this context, alkaline flooding media (reaction media) have been found to be a viable way of destructuring the boundary layer (2a). In the destructuring of the boundary layer (2a) with alkaline reaction media, a multitude of chemical reactions proceed. It is suspected that the hydroxyl ion (OH⁻) contributes to the destructuring of the boundary layer (2a) through neutralization of acid groups (for example carboxyl, phenol or thiol groups) or through hydrolysis of ester bonds. In addition, it is suspected that compounds comprising heteroatoms such as nitrogen or sulfur are deprotonated by the hydroxyl ion, which achieves further destructuring of the boundary layer (2a). The above-described interactions of the hydroxyl ion with the boundary layer (2a) reduce the interfacial tension between the mineral oil (2)/flooding medium phase. This lowers the viscosity of the boundary layer (2a). In addition, the water wettability of the reservoir rock (1) and of the mineral oil phase (2) is increased.

Of all the anions in the flooding medium (i.e. the water phase), the hydroxyl ion has been found to be the most effective. As a result of the adsorption of the hydroxyl ion, the number of negative charges in the surrounding rock (1) is increased and the number of adsorption sites which can form hydrogen bonds is reduced.

The destructuring of the boundary layer (2a) thus likewise achieves a distinct increase in the degree of oil removal and hence in the mineral oil produced.

In summary, it can be stated that three factors are crucial for tertiary mineral oil production:

i) the interfacial tension at the mineral oil/flooding medium (water) boundary layer has to be lowered,

ii) the hydrophilicity of the surrounding rock (1) has to be increased and

iii) the boundary layer (2a) present at the surface of the mineral oil (2) has to be destructured or destroyed.

The prior art describes alkaline surfactant solutions as flooding media for tertiary mineral oil production. For destructuring of the boundary layer (2a), a pH in the range from 9.0 to 10.5 has been found to be particularly advantageous. Colloidal suspensions of clay minerals which may be present in the boundary layer (2a) also have the lowest viscosity in this pH range from 9.0 to 10.5. In the pH range in the range from 9.0 to 10.5, alkaline earth metal hydroxides such as calcium hydroxide and/or magnesium hydroxide additionally have good solubility, and so precipitation of alkaline earth metal hydroxides out of the formation water or flooding water present in the underground mineral oil deposit is very substantially prevented. At pH values of >10.5, calcium hydroxides or magnesium hydroxides precipitate out of the formation water or flooding water. This can block the cavities (3) in the underground mineral oil deposit.

In order to prevent the precipitation of alkaline earth metal hydroxides, it is therefore advantageous to use, as flooding media, alkaline solutions having a high buffer capacity in the pH range from 9 to 10.5. This achieves the effect that the pH of the flooding medium is stable within the range from 9.0 to 10.5 over relatively wide concentration ranges. This gives the flooding medium a pH in the range from 9.0 to 10.5, even if it is diluted by formation water already present in the underground mineral oil deposit. The prior art describes buffer solutions having a high buffer capacity in the advantageous pH range from 9 to 10.5. These include, for example, polyphosphate (tripolyphosphate) buffers, silicate buffers, ammonia buffers and borate buffers. The tripolyphosphate buffer is unsuitable for use in mineral oil deposits with temperatures of ≧50° C. The tripolyphosphate system is hydrolyzed rapidly at these temperatures, forming trisodium polyphosphate which leads to insoluble precipitates with calcium, magnesium and iron ions present in the formation water and/or flooding water. The silicate buffer system is also associated with technical difficulties since sodium silicate is likewise hydrolyzed and has a tendency to polycondensation.

SU 1169403 describes a flooding medium system comprising sodium tetraborate. For the preparation, borax is dissolved in water. The flooding medium system additionally comprises 0.33 to 1% by weight of surfactants. A disadvantage of this flooding medium system is that the sodium tetraborate (borax) used is only of limited water solubility. Furthermore, the flooding medium system is only of limited usability in underground mineral oil deposits having a high salt content in the formation water, since the sodium tetraborate is incompatible with the alkali metals and alkaline earth metals present in the formation water.

It is thus an object of the present invention to provide a method for producing mineral oil from an underground mineral oil deposit, which has the disadvantages described in the prior art only to a reduced degree, if at all. It is a further object of the invention to provide a composition (Z) having a high buffer capacity in the pH range from 9.0 to 10.5. The composition (Z) is to be suitable as a medium for mineral oil production, especially as a flooding medium for tertiary mineral oil production. The composition (Z) is additionally to be suitable for destructuring or destroying boundary layers (2a). The composition (Z) is additionally to lower the interfacial tension between the mineral oil phase (2) and the phase of the composition (Z). The composition (Z) is additionally to convert the hydrophobic character of the surrounding rock (1) to a hydrophilic character. The composition (Z) is also to be suitable for use in mineral oil deposits comprising formation water with a high salt content, i.e. with a high content of alkaline earth metal and alkali metal ions. The density, the viscosity, the pH and the freezing point of the composition (Z) are to be regulatable over a wide range. The composition (Z) is to be inexpensive and simple to produce and simple to handle.

This object is achieved by a method for producing mineral oil from an underground mineral oil deposit into which at least one injection well and at least one production well have been sunk, by injecting a composition (Z) into at least one injection well and withdrawing mineral oil from at least one production well, wherein the composition (Z) is produced by mixing at least the following components:

(i) 1 to 30% by weight of a sodium borate,

(ii) 10 to 80% by weight of glycerol and

(iii) 10 to 50% by weight of water,

where the percentages by weight are each based on the total weight of the composition (Z).

It has been found that, surprisingly, the process according to the invention can distinctly enhance the yield of mineral oil in the course of tertiary mineral oil production. The composition (Z) leads to effective destructuring or destruction of the boundary layer (2a). The composition (Z) and the method according to the invention distinctly lower the interfacial tension between the mineral oil phase and the phase comprising the composition (Z).

Furthermore, the process according to the invention converts the hydrophobic character of the surrounding rock (1) in the underground mineral oil deposit to a hydrophilic character. As a result, the surrounding rock (1) is wetted with water, which results in detachment of the mineral oil (2) accumulated on the surrounding rock (1). The composition (Z) thus achieves effective displacement of mineral oil (2) from the underground mineral oil deposit. In this context, the composition (Z) functions as a flooding medium and displaces the oil from the injection well in the underground mineral oil deposit in the direction of the production well. Mineral oil is withdrawn subsequently from the production well.

According to the present invention, the composition (Z) is produced by mixing at least the following components:

(i) 1 to 30% by weight of a sodium borate,

(ii) 10 to 80% by weight of glycerol and

(iii) 10 to 50% by weight of water,

where the percentages by weight are each based on the total weight of the composition (Z).

It has been found to be advantageous when the composition (Z) comprises 0.5 to 5% by weight of at least one surfactant (component (iv)).

The present invention thus also provides a method in which the composition (Z) additionally comprises component (iv) 0.5 to 5% by weight of at least one surfactant, where the percentages by weight are each based on the total weight of the composition (Z).

The present invention thus also provides a method in which the composition (Z) is produced by mixing at least the following components:

(i) 1 to 30% by weight of a sodium borate,

(ii) 10 to 80% by weight of glycerol,

(iii) 10 to 50% by weight of water and

(iv) 0.5 to 5% by weight of at least one surfactant,

where the percentages by weight are each based on the total weight of the composition (Z).

Furthermore, it has been found advantageous when the composition (Z) comprises 0.5 to 5% by weight of at least one surfactant (component (iv)) and additionally 2 to 20% by weight of urea (component (v)).

The present invention thus also provides a method in which the composition (Z) additionally comprises the components:

(iv) 0.5 to 5% by weight of at least one surfactant and

(v) 2 to 20% by weight of urea,

where the percentages by weight are each based on the total weight of the composition (Z).

The present invention thus also provides a method in which the composition (Z) is produced by mixing at least the following components:

(i) 1 to 30% by weight of a sodium borate,

(ii) 10 to 80% by weight of glycerol,

(iii) 10 to 50% by weight of water,

(iv) 0.5 to 5% by weight of at least one surfactant and

(v) 2 to 20% by weight of urea,

where the percentages by weight are each based on the total weight of the composition (Z).

According to the present invention as component (i) a sodium borate is used. Within the context of the present invention, the term “sodium borate” comprises all sodium salts of boric acid. Sodium salts of boric acid are known to the skilled person. Sodium salts of boric acid can be derived from orthoboric acid (H₃BO₃), metaboric acid (HBO₂) and polyboric acid. Polyboric acids are known to the skilled person. The person skilled in the art furthermore knows that some of the polyboric acids can not be isolated in their free form but that their sodium salts may be isolated. The sodium borates can also comprise water of crystallization.

Preferred sodium borates are sodium tetraborates. Sodium tetraborates are known to the skilled person. They can comprise water of crystallization. Preferably a sodium tetraborate selected from the group consisting of sodium tetraborate (Na₂B₄O₇), sodium tetraborate pentahydrate (Na₂B₄O₇.5H₂O), sodium tetraborate decahydrate (Na₂[B₄O₅(OH)₄].8H₂O) and mixtures thereof is used. A particularly preferred borate compound is sodium tetraborate decahydrate (Na₂B₄O₇.10H₂O).

Sodium tetraborate (Na₂B₄O₇) is also referred to as disodium tetraborate. The sodium tetraborate may comprise water of crystallization. Anhydrous sodium tetraborate (Na₂B₄O₇) bears CAS number 1330-43-4. Sodium tetraborate decahydrate (NaB₄O₇.10H₂O) bears CAS number 1303-96-4. Another way of representing the chemical formula of sodium tetraborate decahydrate is (Na₂[B₄O₅(OH)₄].8H₂O). Sodium tetraborate decahydrate is also referred to as borax, or as tincal or sodium borate. Within the present invention the term sodium borate comprises as defined above all sodium salts of boric acid. Sodium tetraborate pentahydrate (Na₂B₄O₇.5H₂O) bears CAS number 12179-04-3.

The present invention thus also provides a method in which the composition (Z) is produced by mixing at least the following components:

(i) 1 to 30% by weight of Na₂B₄O₇,

(ii) 10 to 80% by weight of glycerol and

(iii) 10 to 50% by weight of water,

where the percentages by weight are each based on the total weight of the composition (Z).

The present invention thus also provides a method in which the composition (Z) is produced by mixing at least the following components:

(i) 1 to 30% by weight of Na₂B₄O₇,

(ii) 10 to 80% by weight of glycerol,

(iii) 10 to 50% by weight of water and

(iv) 0.5 to 5% by weight of at least one surfactant,

where the percentages by weight are each based on the total weight of the composition (Z).

The present invention thus also provides a method in which the composition (Z) is produced by mixing at least the following components:

(i) 1 to 30% by weight of Na₂B₄O₇,

(ii) 10 to 80% by weight of glycerol,

(iii) 10 to 50% by weight of water,

(iv) 0.5 to 5% by weight of at least one surfactant and

(v) 2 to 20% by weight of urea,

where the percentages by weight are each based on the total weight of the composition (Z).

The sodium borates used according to the present invention are only of low water solubility. At room temperature (20° C.), 2.7 g of borax dissolve in 100 g of water. The solubility of borax in glycerol is much higher. At 15° C., 60 g of borax dissolve in 100 g of glycerol. If the glycerol comprises water, the solubility of the borax decreases. At 20° C., 52.6 g of borax are soluble in 100 g of a mixture comprising 98.5% by weight of glycerol and 1.5% by weight of water. At 20° C., 47.2 g of borax are soluble in 100 g of a mixture comprising 86.5% by weight of glycerol and 13.5% by weight of water.

Boric acid can form from borates, especially from the sodium borates according to the present invention, under the action of water. This is shown hereinafter by way of example, using the example of sodium tetraborate (anhydrous) and using the example of sodium tetraborate pentahydrate:

Na₂B₄O₇+7H₂O→2NaB(OH)₄+2B(OH)₃

((Na₂B₄O₇(5H₂O))+2H₂O→2NaB(OH)₄+2B(OH)₃

As shown above, boric acid forms from sodium borates on dissolution in water. It is presumed, that this boric acid with glycerol forms a glycerol-boric acid complex of the formula (I). The glycerol-boric acid complex (I) and salts thereof are of much better water solubility than boric acid or borax.

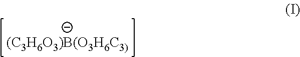

The glycerol-boric acid complex of the formula (I) derives formally through a complexation reaction of boric acid (B(OH)₃) with two molecules of glycerol (IUPAC name: propane-1,2,3-triol). The complexation reaction follows the following reaction equation:

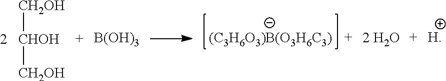

The proton racts with the tetrahydroxyborate-anion ([B(OH)₄]⁻), which was formed during the preparation of boric acid starting from sodium tetraborate, to give boric acid and water. This reaction is known to the skilled person.

Boric acid is a very weak monobasic acid. It acts not as a proton (H⁺) donor but as an (OH⁻) acceptor. Boric acid has an acid strength of pKₐ=9.25. The above-described formation of the glycerol-boric acid complex (I) achieves a distinct rise in the acid strength by up to 4 orders of magnitude. The pKₐ of the glycerol-boric acid complex (I) depends on the glycerol concentration and boric acid concentration and is generally in the range from 5.0 to 6.5.

The glycerol-boric acid complex of the general formula (I) comprises, in accordance with the invention, all the possible isomers that can be derived formally from the empirical formula

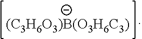

The general formula (I) comprises especially the following isomers Ia to Ie:

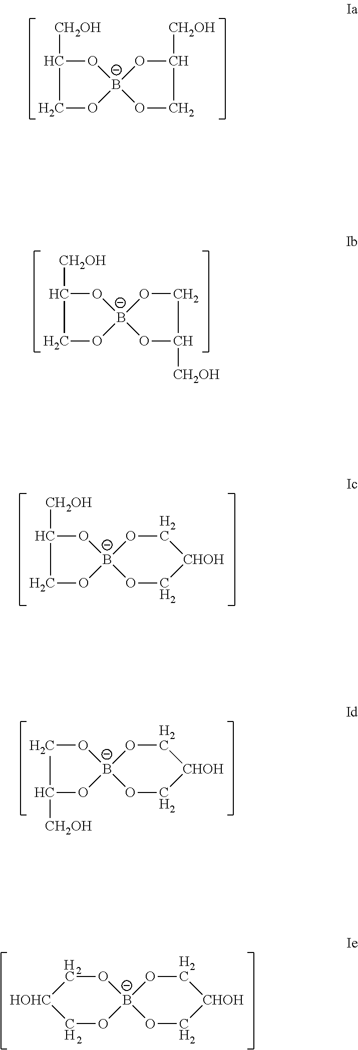

It is assumed, that the glycerol-boric acid complex of the general formula (I) comprises in general Na⁺ as counterion.

The percentages by weight in relation to component (i) are based on anhydrous sodium tetraborate. If sodium tetraborate comprising water of crystallization is used, the weight of the water of crystallization is not counted with component (i). Any water of crystallization present is counted with the percentages by weight of the water present in the composition (Z).

The percentages by weight in relation to component (ii) are based on pure glycerol. If the glycerol used for production of the composition (Z) is a mixture comprising glycerol and water, the water present in this mixture is counted with the percentages by weight of the water present in the composition (Z).

The glycerol present in the composition (Z) may originate from any desired sources. The glycerol used is preferably what is called crude glycerol (CG). Crude glycerol (CG) is obtained from natural fats or oils. Glycerol is part of all animal and vegetable fats/oils. Crude glycerol (CG) is obtained in large volumes as a by-product of biodiesel production. For production of biodiesel, vegetable oils, for example rapeseed oil, are transesterified with methanol.

This involves reacting one fat/oil molecule (triacylglyceride) with three methanol molecules to give glycerol and three fatty acid methyl esters. Ten liters of vegetable oil and one liter of methanol give about ten liters of biodiesel and one liter of crude glycerol (CG).

Preferred crude glycerol (CG) has the following composition:

80 to 90% by weight of glycerol,

10 to 20% by weight of water,

0 to 10% by weight of inorganic salts and

0 to 1% by weight of organic compounds other than glycerol,

where the percentages by weight are each based on the total weight of the crude glycerol (CG).

The use of glycerol in the composition (Z) additionally has the advantage that the freezing point of the composition (Z) is lowered. A composition (Z) comprising 66.7% by weight of glycerol, for example, does not freeze until −46.5° C. Through the use of glycerol, it is additionally possible to vary the viscosity of the composition (Z). The more glycerol is present in the composition (Z), the higher the viscosity of the composition (Z). The viscosity of the composition (Z) may be within the range from 1.0 to 1.5 mPas. It will be appreciated that the composition (Z) may also have higher viscosities. This can be achieved, for example, through the use of thickeners. The density of the composition (Z) can also be varied through the use of glycerol. According to the composition (Z) of the above-described components in the composition (Z), the composition (Z) may have a density in the range from 0.96 to 1.3 g/cm³.

The percentages by weight of the water present in the composition (Z) are based on the sum total of the water present in the composition (Z). Any water of crystallization present in the sodium tetraborate, and water which is introduced into the composition (Z) via the glycerol used for production of the composition (Z) (for example crude glycerol CG)), is counted here with the percentages by weight in relation to water in the composition (Z).

Suitable components (iv) are nonionic, anionic and cationic surfactants, and mixtures thereof.

Commonly used nonionic surfactants are, for example, ethoxylated mono-, di- and trialkylphenols, ethoxylated fatty alcohols and polyalkylene oxides. In addition to the unmixed polyalkylene oxides, preferably C₂-C₄-alkylene oxides and phenyl-substituted C₂-C₄-alkylene oxides, especially polyethylene oxides, polypropylene oxides and poly(phenylethylene oxides), particularly block copolymers, especially polymers having polypropylene oxide and polyethylene oxide blocks or poly(phenylethylene oxide) and polyethylene oxide blocks, and also random copolymers of these alkylene oxides, are suitable. Such alkylene oxide block copolymers are known and are commercially available, for example, under the Tetronic and Pluronic names (BASF).

Typical anionic surfactants are, for example, alkali metal and ammonium salts of alkyl sulfates (alkyl radical: C₈-C₁₂), of sulfuric monoesters of ethoxylated alkanols (alkyl radical: C₁₂-C₁₈) and ethoxylated alkylphenols (alkyl radicals: C₄-C₁₂), and of alkylsulfonic acids (alkyl radical: C₁₂-C₁₈).

Suitable cationic surfactants are, for example, the following salts having C₆-C₁₈-alkyl, alkylaryl or heterocyclic radicals: primary, secondary, tertiary or quaternary ammonium salts, pyridinium salts, imidazolinium salts, oxazolinium salts, morpholinium salts, propylium salts, sulfonium salts and phosphonium salts. Examples include dodecylammonium acetate or the corresponding sulfate, disulfates or acetates of the various 2-(N,N,N-trimethylammonium)ethylparaffin esters, N-cetylpyridinium sulfate and N-laurylpyridinium salts, cetyltrimethylammonium bromide and sodium laurylsulfate.

The composition (Z) may additionally comprise further customary additives in amounts of 0.1 to 5% by weight. Further customary additives are, for example, thickeners in order to adjust the viscosity of the composition (Z). Suitable thickeners are selected from the group consisting synthetic polymers, for example polyacrylamide, or copolymers of acrylamide and other monomers, especially monomers comprising sulfo groups, and polymers of natural origin, for example glycosylglucans, xanthans and diutans.

The percentages by weight in relation to the composition (Z) are each based in accordance with the invention on the total weight of the composition (Z), where the sum of the percentages by weight adds up to 100% by weight in each case.

The composition (Z) comprising the glycerol-boric acid complex of the formula (I), in a preferred embodiment, is produced by mixing the above-described components. The mixing can be effected, for example, in a stirred tank. For this purpose, all components are supplied to the stirred tank and subsequently mixed. The sequence of addition of the components is as desired. In order to accelerate the production of the composition (Z), the stirred tank can be heated.

In a preferred embodiment, the composition (Z) has a pH in the range from 9.0 to 10.5.

In a further preferred embodiment, the composition (Z) has a high buffer capacity in the pH range from 9.0 to 10.5.

The present invention thus also provides a method in which the composition (Z) has a pH in the range from 9.0 to 10.5.

The present invention further provides a method which comprises the following method steps:

a) injecting a flooding medium (F) comprising at least 70% by weight of water into the injection well and withdrawing mineral oil from the production well,

b) stopping the injection of the flooding medium (F),

c) injecting the composition (Z) into the injection well and withdrawing mineral oil from the production well,

d) stopping the injection of the composition (Z) and

e) injecting the flooding medium (F) into the injection well and withdrawing mineral oil from the production well.

The flooding medium (F) is different than the composition (Z). The flooding medium (F) preferably comprises at least 80% by weight of water. The flooding medium (F) may additionally comprise further customary additives. Examples of further customary additives are, for example, the thickeners described for the composition (Z). In addition, the above-described surfactants, and also optionally glycerol and/or urea, can be added to the flooding medium (F).

The method steps a) to e) can be repeated as often as desired. This means that, after conclusion of process step e), the injection of the flooding medium (F) is stopped according to process step f). Thereafter, the method is continued with the injection of the composition (Z) according to process step c).

The present invention also provides the composition (Z) as such. For the composition (Z), the details and preferences described above with regard to the method for production of mineral oil from an underground mineral oil deposit apply correspondingly.

The present invention thus also provides a composition (Z) comprising water and a glycerol-boric acid complex of the formula (I)

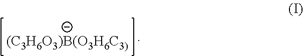

The present invention further provides a composition (Z), wherein the composition (Z) is produced by mixing at least the following components:

(i) 1 to 30% by weight of a sodium borate,

(ii) 10 to 80% by weight of glycerol and

(iii) 10 to 50% by weight of water,

where the percentages by weight are each based on the total weight of the composition (Z).

The present invention further provides a composition (Z), wherein the composition (Z) is produced by mixing at least the following components:

(i) 1 to 30% by weight of a sodium borate,

(ii) 10 to 80% by weight of glycerol,

(iii) 10 to 50% by weight of water and

(iv) 0.5 to 5% by weight of at least one surfactant,

where the percentages by weight are each based on the total weight of the composition (Z).

The present invention further provides a composition (Z), wherein the composition (Z) is produced by mixing at least the following components:

(i) 1 to 30% by weight of a sodium borate,

(ii) 10 to 80% by weight of glycerol,

(iii) 10 to 50% by weight of water,

(iv) 0.5 to 5% by weight of at least one surfactant and

(v) 2 to 20% by weight of urea,

where the percentages by weight are each based on the total weight of the composition (Z).

The present invention further provides a composition (Z), wherein the formula (I) comprises at least one of the isomers selected from the group consisting of the isomers Ia, Ib, Ic, Id and Ie.

The present invention also provides a composition (Z) having a pH in the range from 9.0 to 10.5. The composition (Z) has a high buffer capacity in the pH range from 9.0 to 10.5.

The present invention further provides for the use of a composition (Z) as a medium for mineral oil production from an underground mineral oil deposit. For the inventive use, the details and preferences given above with regard to the method and the composition (Z) apply correspondingly.

Preferably, the composition (Z) is used as a flooding medium. As described above, the flooding medium drives the mineral oil in the underground mineral oil deposit from the injection well in the direction of the production well. Mineral oil is withdrawn from the production well.

Particular preference is given in accordance with the invention to the use of the composition (Z) as a flooding medium for tertiary mineral oil production.

For the composition (Z), the details and preferences given above apply correspondingly.

### LIST OF REFERENCE NUMERALS

1 Rock surrounding the underground mineral oil deposit
2 Mineral oil present in the underground mineral oil deposit
2a Boundary layer 2a
3 Cavities in the underground mineral oil deposit
Z Composition Z

### FIGURES

FIG. 1 State before the performance of secondary production methods

FIG. 2 State after the performance of secondary production methods

FIG. 3a Behavior of mineral oil 2 on alteration of the hydrophobic character of the surrounding rock 1 to a hydrophilic character

FIGS. 4, 5 Behavior of mineral oil 2 on performance of the method according to the invention

FIG. 6 Mineral oil 2 having a boundary layer 2a

FIG. 7 Solubility of sodium tetraborate (borax) as a function of the glycerol concentration of a mixture comprising glycerol and water

FIG. 8 Dependence of the density of a composition (Z) on the glycerol concentration of a mixture comprising glycerol and water

FIG. 9 Evolution of mineral oil production on use of the method according to the invention.

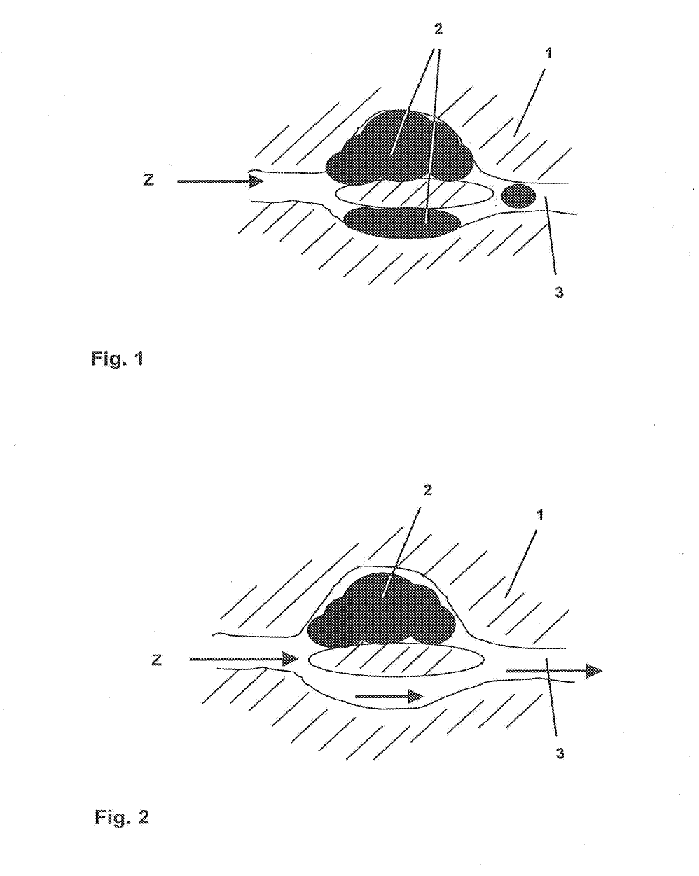

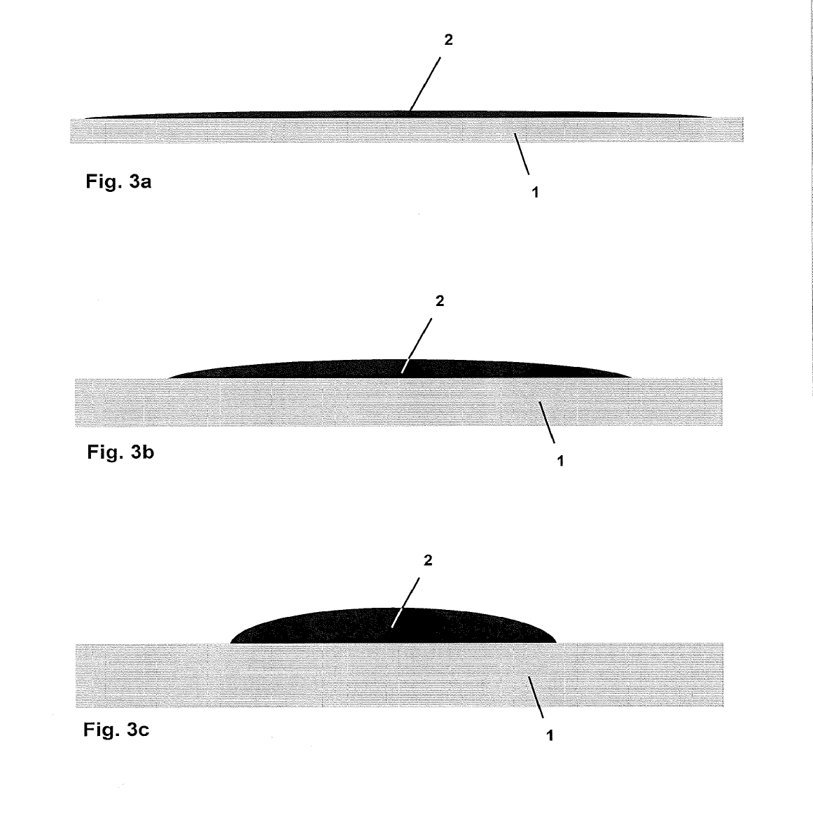

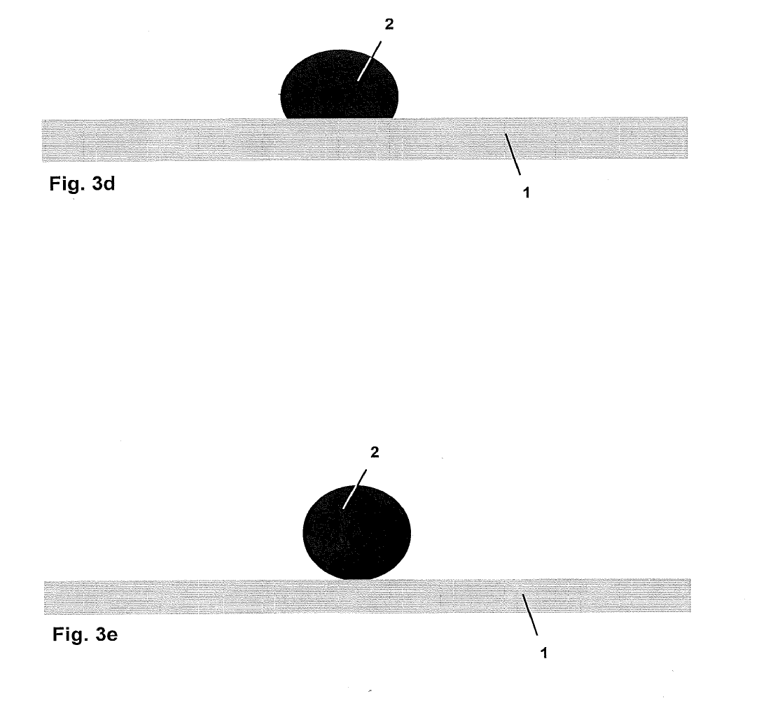

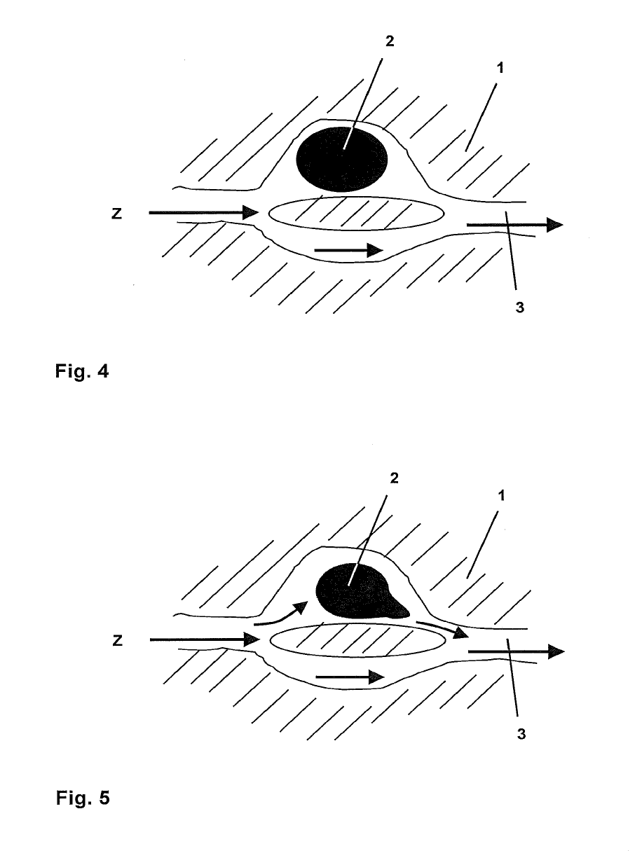

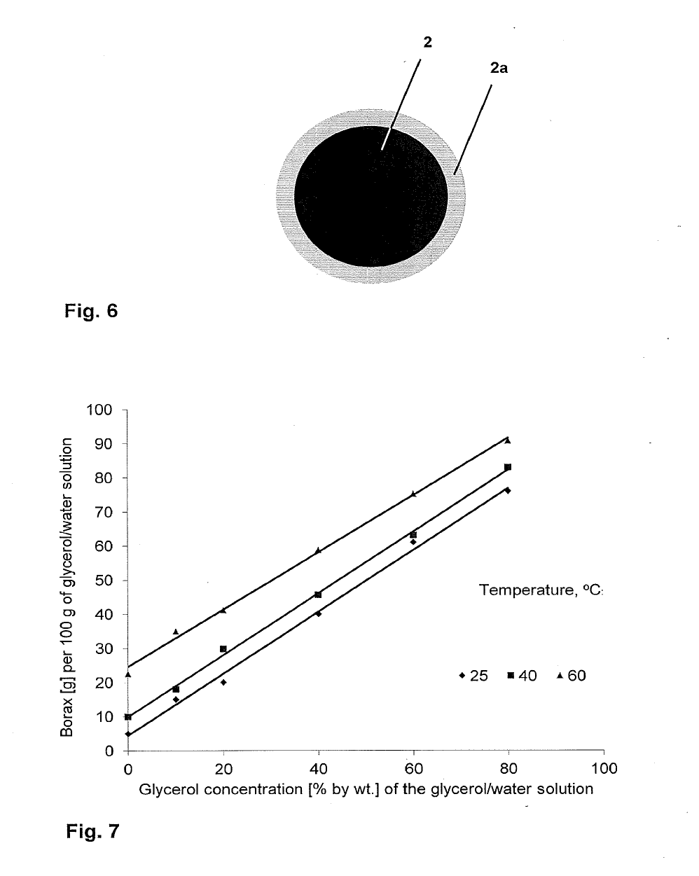

FIGS. 1 to 6 have already been described in the description above. FIG. 7 shows the solubility of sodium tetraborate (borax) as a function of the glycerol concentration at different temperatures. It is apparent from FIG. 7 that the solubility increases with increasing glycerol concentration. In addition, the solubility of borax increases with rising temperature.

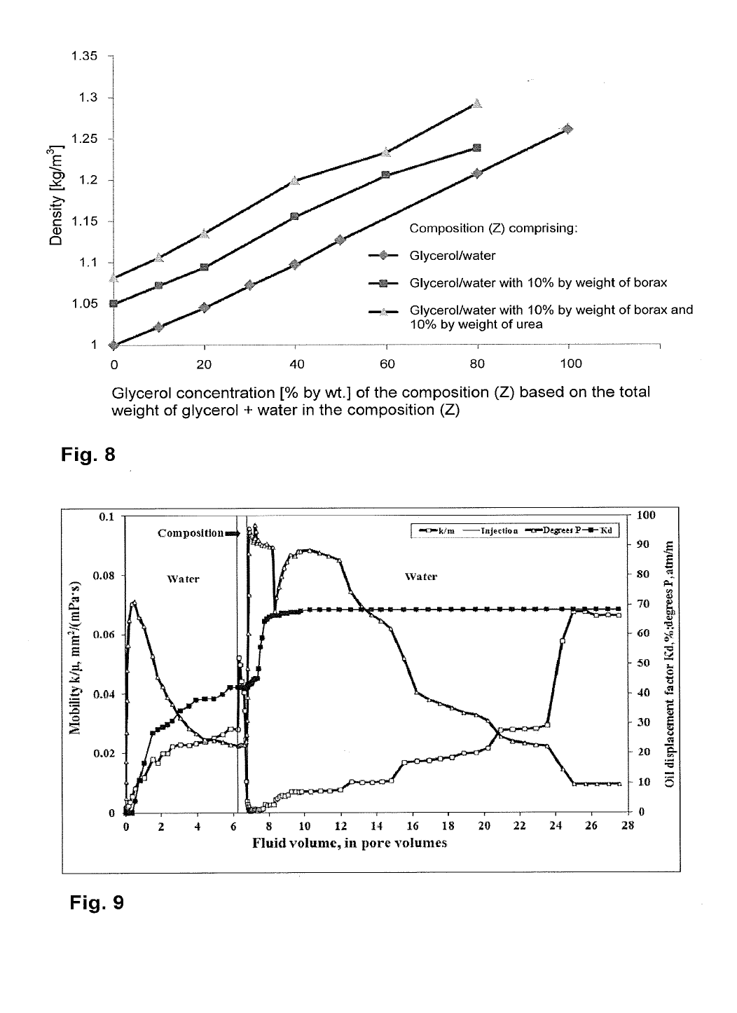

FIG. 8 shows the dependence of the density of the composition (Z) as a function of the glycerol concentration. It is apparent from FIG. 8 that the density of the composition (Z) increases with increasing glycerol concentration.

FIG. 9 shows the evolution of the mineral oil production rate on use of the method according to the invention. FIG. 9 is explained in detail in the example which follows.

The present invention is illustrated in detail by the example which follows, but without restricting it thereto.

The influence of the composition (Z) has been tested using a heterogeneous deposit model. For this purpose, a column was filled with a synthetic drill core which simulates the surrounding rock (1) in which mineral oil (2) is enclosed in cavities (3).

The column had a length of 300 mm and a diameter of 20 mm.

Subsequently, the column was treated with water as a flooding medium or with the composition (Z) as a flooding medium. The treatment here was conducted at a temperature in the range from 20 to 23° C. The composition (Z) used was a mixture which comprised 2% by weight of a complex surfactant, 10% by weight borax, 80% by weight of glycerol and 8% by weight of water.

The glycerol source used was crude glycerol (CG). The complex surfactant is a partly sulfonated hydroxyethylisononylphenol based on propylene trimers having an ethoxylation of 12 with addition of ethylene glycol (25-30% by weight). This is a hydrophobic emulsion consisting of several components: liquid hydrocarbon (mineral oil, gasoline etc.), emulsifier, hydrophobizer and an aqueous solution of calcium chloride.

A synthetic drill core is produced from compressed sand in a metal tube. By conventional methods, the pore volume of the core is measured. Thereafter, the core is saturated with mineral oil.

The synthetic drill core was subsequently treated first with water, then with the composition (Z) and then with water under pressure again. During the performance of the experiment, the temperature, the inlet and outlet pressure on the column, the amount of mineral oil displaced, which is withdrawn from the column, and the amount of water or composition (Z) which is withdrawn from the column were measured every five minutes.

On the basis of this data, the pressure gradient (degrees P [atm/m]), the filtration rate (V [m/d]), the mobility of the liquids in the column (k/μ [mm²/(mPas)]) and the oil displacement coefficient (Kd) were measured.

The results of the experiment are shown as a graph in FIG. 9. On the horizontal axis is stated the total volume of water or composition (Z) which is injected into the column. The total volume (fluid volume, in pore volumes) is normalized to the pore volume of the drill core. The total pore volume of the drill core is set to 1. The value 6 on the horizontal axis of FIG. 9 thus means that a water volume corresponding to six times the pore volume of the drill core has been injected.

On the left-hand vertical axis in FIG. 9 is plotted the mobility of the injected liquids (water or composition (Z)). In FIG. 9, this parameter is referred to as “mobility k/μ, mm²/(mPas)”.

On the right-hand vertical axis in FIG. 9 is plotted the oil displacement coefficient (Kd) and the pressure gradient (degrees P). On the right-hand vertical axis in FIG. 9, these parameters are referred to as “oil displacement factor Kd, and degrees P, atm/m”.

The curve with the white squares in FIG. 9 indicates the mobility of the liquids, i.e. of the water or of the composition (Z). The curve with the black squares indicates the oil displacement coefficient (Kd). The curve with the white triangles indicates the pressure gradient.

In the range from 0 to 6 on the horizontal axis in FIG. 9, water is first used as the flooding medium. In the range above six and below seven, which is marked by the two vertical lines, the composition (Z) is injected into the column. The vertical lines are marked in FIG. 9 as “injection”. In the range above seven, water is subsequently used again as the flooding medium.

FIG. 9 shows that the pressure gradient rises significantly at the start of the experiment. The mobility of the liquids and the oil displacement coefficient likewise rise slightly.

After injection of the composition (Z), the pressure gradient at first rises significantly, but subsequently declines continuously. The mobility of the liquids at first decreases after injection of the composition (Z). With continuing injection of further liquids, however, the mobility of the liquids rises continuously and, at the end of the experiment, is well above the starting value prior to injection of the composition (Z).

After injection of the composition (Z), the oil displacement coefficient rises significantly and subsequently remains constant at a level well above the level prior to injection of the composition (Z).

1-11. (canceled)

12: A method for producing mineral oil from an underground mineral oil deposit into which at least one injection well and at least one production well have been 5 sunk, by injecting a composition (Z) into at least one injection well and withdrawing mineral oil from at least one production well, wherein the composition (Z) is produced by mixing at least the following components:
1 to 30% by weight of a sodium borate, 10
10 to 80% by weight of glycerol and
10 to 50% by weight of water,
where the percentages by weight are each based on the total weight of the composition (Z).

13: The method according to claim 12, wherein the composition (Z) further comprises component:
0.5 to 5% by weight of at least one surfactant,
where the percentages by weight are each based on the total weight of the composition (Z).

14: The method according to claim 12, wherein the composition (Z) further comprises the following components:
0.5 to 5% by weight of at least one surfactant and
2 to 20% by weight of urea,
where the percentages by weight are each based on the total weight of the composition (Z).

15: The method according to claim 12, wherein, the composition (Z) comprises a glycerol-boric acid complex of the formula (I):

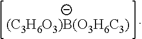

16: The method according to claim 12, wherein the formula (I) comprises at least one of the isomers selected from the group consisting of the isomers Ia, Ib, Ic, Id and Ie:

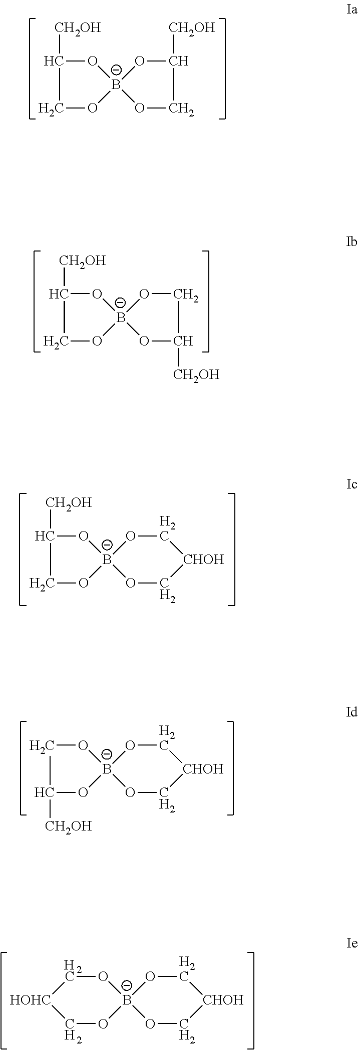

17: The method according to claim 12, wherein the composition (Z) has a pH in the range from 9.0 to 10.5

18: The method according to claim 12, which comprises the following method steps:
injecting a flooding medium (F) comprising at least 70% by weight of water into the injection well and withdrawing mineral oil from the production well,
stopping the injection of the flooding medium (F),
injecting the composition (Z) into the injection well and withdrawing mineral oil from the production well, stopping the injection of the composition (Z) and
injecting the flooding medium (F) into the injection well and withdrawing mineral oil from the production well.

19: A composition (Z) that comprises:
1 to 30% by weight of a sodium borate,
10 to 80% by weight of glycerol, and
10 to 50% by weight of water, and
optionally, 0.5 to 5% by weight of at least one surfactant, and
optionally, 2 to 20% by weight of urea,
where the percentages by weight are each based on the total weight of the composition (Z).

20: A method for mineral oil production from an underground mineral oil deposit comprising contacting the mineral oil deposit with composition (Z) according to claim 19 as a medium from mineral oil production, wherein composition (Z) is produced by mixing at least the following components:
1 to 30% by weight of a sodium borate,
10 to 80% by weight of glycerol and
10 to 50% by weight of water,
where the percentages by weight are each based on the total weight of the composition (Z).

21: A method for mineral oil production from an underground mineral oil deposit comprising contacting the mineral oil deposit with composition (Z) according to claim 19 as a flooding medium, wherein composition (Z) is produced by mixing at least the following components:
1 to 30% by weight of a sodium borate,
10 to 80% by weight of glycerol and
10 to 50% by weight of water,
where the percentages by weight are each based on the total weight of the composition (Z).

22: A method for tertiary mineral oil production from an underground mineral oil deposit comprising contacting the mineral oil deposit with composition (Z) according to claim 19 as a flooding medium for tertiary oil production, wherein composition (Z) produced by mixing at least the following components:
(i) 1 to 30% by weight of a sodium borate,
(ii) 10 to 80% by weight of glycerol and
(iii) 10 to 50% by weight of water,
as a flooding medium.
where the percentages by weight are each based on the total weight of the composition (Z).
